(19) United States
(12) Patent Application Publication
(10) Pub. No.: US 2019/0017532 A1
(43) Pub. Date: Jan. 17, 2019

(54) ANTI-LOOSENING WASHER

(71) Applicant: Ming Yue, Beijing (CN)

(72) Inventor: Ming Yue, Beijing (CN)

(21) Appl. No.: 15/649,280

(22) Filed: Jul. 13, 2017

(51) Int. Cl. F16B 39/24; F16B 5/02

(52) U.S. Cl. CPC F16B 39/24; F16B 5/0241

(57) ABSTRACT

A washer is provided. The washer includes a first material and a second material. The first material surrounds the second material. The first material is harder than the second material. The second material has a threaded hole in its center. The washer may be part of a system comprising a nut, a bolt with a bolt head and a threaded bolt screw, and a substrate. The washer is first fixed over the threaded the bolt screw, a nut is then fixed over the washer on the threaded bolt screw, such that a pressure formed to inflate and squeeze the threads of the threaded hole in the second material of the washer to mate better with the threads of the threaded bold screw, thus providing an anti-loosing effect.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a washer. More particularly, certain embodiments of the invention relate to a nut bolt washer.

A nut is a type of fastener with a threaded hole. Nuts are almost always used in conjunction with a mating bolt to fasten two or more parts together. There may be practically no industry in the world today that may not need to use some form of nut-bolt system for fastening some part or other. The nut and the bolt are typically kept together by a combination of their threads' friction, a slight stretching of the bolt, and compression of the parts to be held together. The nut and the bolt are often fastened together with intervening washers. The washer may be used to distribute the pressure of the nut evenly over the surface, so that the surface of the part to be fastened may not be damaged, and to ensure that the nut is pressed against a smooth surface, reducing the chance that it'll gradually loosen because it's in contact with an uneven surface. The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that in applications where vibration or rotation may work a nut loose, various locking mechanisms may be employed: lock washers, jam nuts, specialist adhesive thread-locking fluid such as Loctite, safety pins (split pins) or lockwire in conjunction with castellated nuts, nylon inserts (Nyloc nut), or slightly oval-shaped threads, etc . . . . A variety of washer's having variety of shapes and made of various materials may be employed with the nuts to minimize loosening of nuts due to vibration and in conditions where the nut-bolt combination may endure shock.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a perspective view of an exemplary washer, in accordance with an embodiment of the present invention;

FIG. 2 illustrates a perspective view of an exemplary washer, in accordance with an embodiment of the present invention;

FIG. 3 illustrates a cross sectional view of a nut-bolt combination tightened with an exemplary washer, in accordance with an embodiment of the present invention;

FIG. 4 illustrates a cross sectional view of a nut-bolt combination tightened with an exemplary washer, in accordance with an embodiment of the present invention; and

FIG. 5 illustrates a cross sectional view of a nut-bolt combination tightened with an exemplary washer, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms” comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

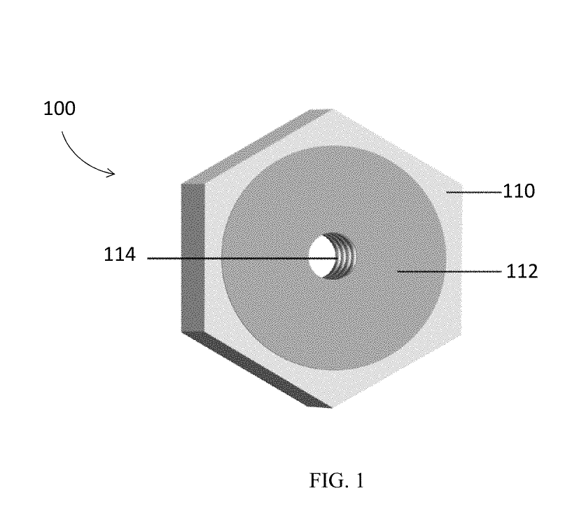

In one embodiment, the washer described herein may be made of two types of materials i.e., a central soft material and an external hard material. The central soft material may have a threaded hole in the soft part. In one exemplary embodiment, referring to FIG. 1, is illustrated a perspective view 100 of an exemplary washer, in accordance with an embodiment of the present invention. In an exemplary embodiment, the washer 100 may include a first material 110 and a second material 112. The first material 110 may surround the second material 112, in one exemplary embodiment. The first material 110 may be harder than the second material 112. It may be appreciated by a person with ordinary skill in the art, in light of and in accordance with the teachings of the present invention that hardness is a measure of how resistant solid matter may be to various kinds of permanent shape change when a compressive force is applied. In one embodiment, the second material 112 may include a threaded hole 114 at the center. In one embodiment, the first material 110 is a harder material than the second material 112. In one embodiment, the first material 110 may include but is not limited to steel, for example carbon steel, spring steel, and stainless steel; metal, for example, copper, brass, aluminum, titanium, iron, bronze, and zinc; alloy, for example, silicon bronze, Inconel® i.e., austenitic nickel-chromium super alloys, Monel® i.e., nickel alloys, and hastelloy i.e., nickel alloys; polymers, for example, thermoplastics and thermosetting polymers, for example, polyethylene, Teflon® i.e., polytetrafluoroethylene; and Nylon®, for examnylon 6, nylon 66, nylatron, and tecamid MDS; specialty materials, for example fibers, ceramics, rubber, felt, leather, bimetals, and mica. In one embodiment, the second material 112 may include but is not limited to steel, for example carbon steel, spring steel, and stainless steel; metal, for example, copper, brass, aluminum, titanium, iron, bronze, and zinc; alloy, for example, silicon bronze, Inconel, Monel, and hastelloy; polymers, for example, thermoplastics and thermosetting polymers, for example, polyethylene, Teflon; and Nylon, for example Nylon 6, Nylon 66, Nylatron, and Tecamid MDS; specialty materials, for example fibers, ceramics, rubber, felt, leather, bimetals, and mica. Accordingly, in various embodiments the first material 110 and the second material 112 may be any material chosen from above as long as the first material is harder than the second material. In one embodiment, the first material 110 may be a hard metal like steel. In one embodiment, the second material 112 may be a relatively softer metal to steel like copper.

In one embodiment, the first material 110 and the second material 112 may be integrated or fused or forged together to form a washer. In another embodiment, the first material 110 and the second material 112 may be separate parts that may be put together before being used as a washer.

In one embodiment, the washer may have an overall shape of a circle or a polygon. In one embodiment, the first material 110 in the washer, may have an overall shape of a circle or a polygon. In one embodiment, the second material 112 in the washer, may have an overall shape of a circle or a polygon. It may be appreciated by a person with ordinary skill in the art, in light of and in accordance with the teachings of the present invention that the most common shape for a washer may be hexagonal, for similar reasons as the bolt head—6 sides may give a good granularity of angles for a tool to approach from, particularly in tight spots, but more (and smaller) corners may be vulnerable to being rounded off. It takes only ⅙th of a rotation to obtain the next side of the hexagon and grip is optimal. Other specialized shapes exist for certain needs, such as wingnuts for finger adjustment and captive nuts, for example, cage nuts, for inaccessible areas. Moreover, a wide variety of nuts exists, from household hardware versions to specialized industry-specific designs that are engineered to meet various technical standards. Fasteners used in automotive, engineering, and industrial applications usually need to be tightened to a specific torque setting, using a torque wrench. Nuts may be graded with strength ratings compatible with their respective bolts. In one embodiment, the first material may have a hexagonal shape and the second material may have a circular shape.

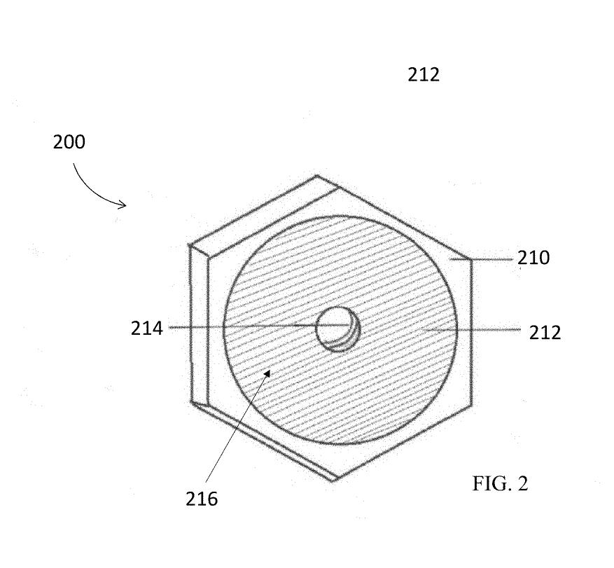

Referring to FIG. 2, is illustrated a perspective view 200 of an exemplary washer, in accordance with an embodiment of the present invention. In an exemplary embodiment, the washer 200 may include a first material 210 and a second material 212. The first material 210 may be harder than the second material 212. The second material 212 may have a threaded hole 214 at the center. In one embodiment, the surface of the washer 216 and a nut (not shown in figure) may be rough. Thus, when the nut may be tightened, the soft part with the rough surface may significantly increase the resistance between the washer and nut and may provide an anti-loosening effect. Typically, the washer may be used to protect the surface of the “part” which need to be assembled from damage or dents due to direct contact with a nut. In various embodiments, the surface of the second material 212 may be made rough by cutting lines or shapes on the surface 216.

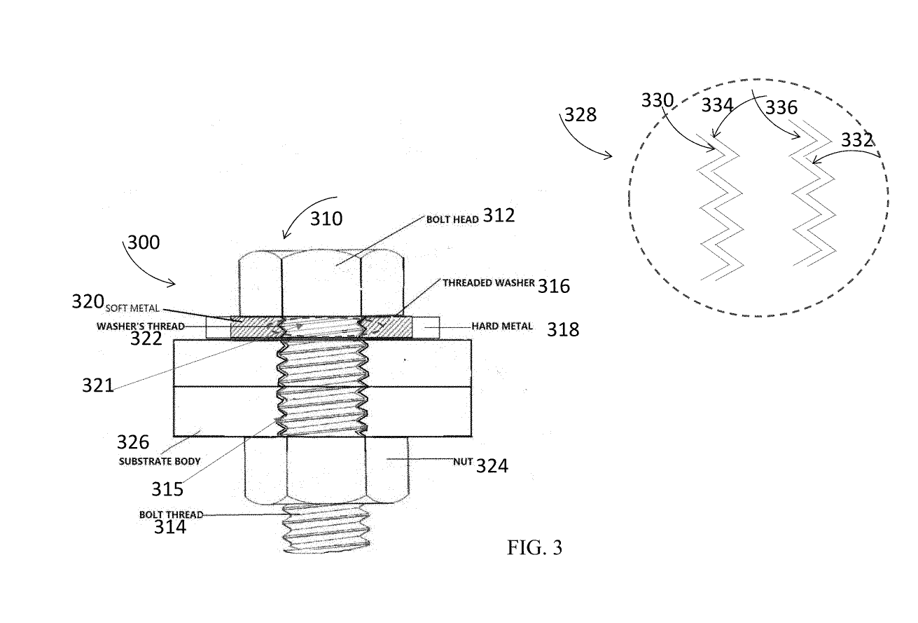

Referring to FIG. 3, is illustrated a cross sectional view 300 of a nut-bolt combination tightened with an exemplary washer, in accordance with an embodiment of the present invention. FIG. 3 shows a bolt 310 with a bolt head 312 connected to a threaded bolt screw 314. FIG. 3 also shows a washer 316. The washer 316 includes a first material 318 (for example, outer hard metal), a second material 320 (for example inner soft metal), and a central hole 321 with threads 322. A nut 324 is screwed on the threaded bolt screw 314. A substrate body 326 is shown sandwiched between the washer 316 and the nut 324. The diameter of the second material 320 may be greater than the diameter of the nut 324.

During a typical use of the washer 316, the washer 316 may be screwed onto the threaded bolt screw 314 (having male and female threads) with the bolt passing through the threaded hole 321 (having male and female threads) in the center of the second material 320. The threaded bolt screw 314 is then passed through the hole 315 in the substrate body 326 that needs to be fixed together. The nut 324 may then be screwed onto the threaded bolt screw 324 such that the substrate body is sandwiched between the washer 315 and the nut 324. As the nut is screwed onto the bolt, the thread 322 of the soft material 320 the pressure would force the female thread of the soft part of washer to inflate and squeeze into the thread of the threaded bolt screw 314, i.e., into the mating thread of the bolt 300 under a pressure created by the tightening nut 324. The surrounding first material 318 of the washer 316 may not allow any release of the pressure from the tightening nut 324 so that the pressure would make the second material 320 i.e., soft part of the washer 316 to inflate and force the thread 322 of the washer to bite into the threads of the threaded bolt screw 314. As indicated in the blown-up portion 328 in FIG. 3, the threads 330, 332 of the washer 316 are forced into the threads 334, 336 of the threaded bolt screw 314 when the nut 324 is fastened. Further, the soft part of the washer may be locked tightly with the hard nut under the pressure, especially when their surface is rough. In certain embodiments (not shown in figure), a second washer may be fixed over the nut 324 and a second nut may be fixed over the washer to form two layers of the washer nut combination. This may lead to the nut 324 being fixed relatively strongly in the required position on the threaded bolt screw.

In one embodiment, (not shown in figure) a washer 315 may be screwed on to the threaded bolt screw 314 on either side of the substrate body 326. Thus, the washer 316 may lock its position on the bolt 310.

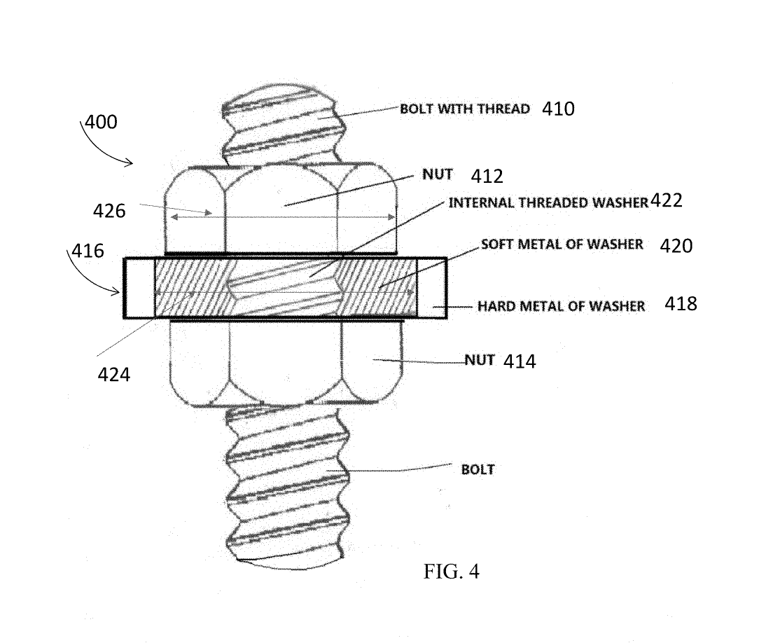

In one embodiment, two or more washer-nut may be locked on a fixed position on a bolt. Referring to FIG. 4, is illustrated a cross sectional view 400 of a nut-bolt combination tightened with an exemplary washer, in accordance with an embodiment of the present invention. FIG. 4 shows a bolt with thread 410, a first nut 412, a second nut 414, a washer 416, first material of washer 418, second material of washer 420, and central threaded portion of washer 422. In an exemplary embodiment, shown in FIG. 4, when there is a need for a nut to be fixed at a point on the threaded portion of bolt 410, the first nut 412 may be fixed using a second nut 414 and a washer 416. The diameter 424 of the second material 420 of the washer is bigger than the diameter 426 of the nut 412 or the diameter of the nut 414. Accordingly, any part may be locked on a certain position on the bolt by using the washer-nut combination discussed herein.

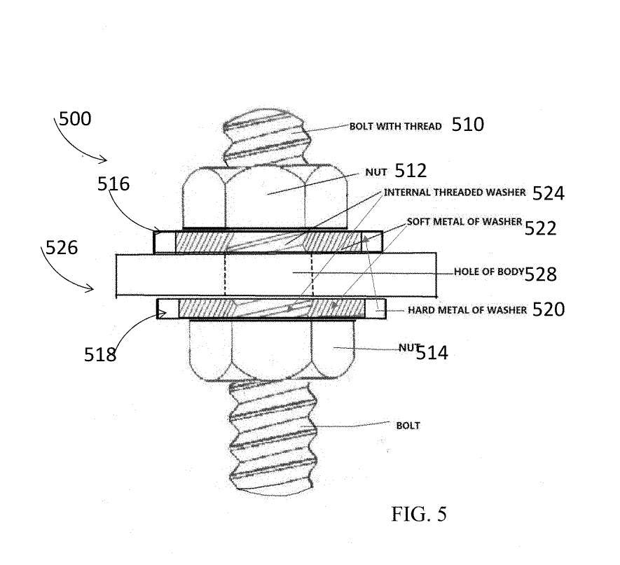

Referring to FIG. 5, is illustrated a cross sectional view 500 of a nut-bolt combination tightened with an exemplary washer, in accordance with an embodiment of the present invention. FIG. 5 shows a bolt with thread 510, a first nut 512, a second nut 514, a first washer 516, a second washer 518, first material of washers 520, second material of washers 522, central threaded portion of washers 524, and a substrate body 528. In an exemplary embodiment, shown in FIG. 5, when there is a need for a substrate body 528 to be fixed at any point on the threaded portion of bolt 510, the substrate body 528 may be sandwiched in by screwing in a first washer 516 and a second washer 518 one each on either side of the substrate body 510 after passing the bolt 510 through the substrate body 528. The first nut 512 and the second nut 514 may then be fixed over the washers 516 and 518 respectively. Accordingly, any part may be locked on a certain position on the bolt by using the washer-nut combination discussed herein.

It may be appreciated by a person with ordinary skill in the art, in light of and in accordance with the teachings of the present invention, that though this disclosure has been described with reference to certain positions of the washer and nut with reference to a substrate body to be fixed with a bolt, in various embodiments, various combinations and positions of the washer nut combination may be employed to fix or join different substrate bodies as required. Accordingly, the dimensions of the various parts and features, and material used for making the washer may differ to suit the intended purpose ensuring that the first (outer) material is hard, second (inner) material is soft, and diameter of the second material is greater than the diameter of the nut.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a washer according to the present invention will be apparent to those skilled in the art. Various aspects of the invention have been described above by way of illustration, and the specific embodiments disclosed are not intended to limit the invention to the particular forms disclosed. The particular implementation of the washer may vary depending upon the particular context or application. By way of example, and not limitation, the washer described in the foregoing were principally directed to nut-bolt implementations to enable the use of tightening or fixing parts together; however, similar techniques may instead be applied to applications that require the anti-loosening effect, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

1. A washer comprising:
a first material and a second material;
wherein the first material surrounds the second material, wherein the first material is harder than the second material; and
wherein the second material has a threaded hole in its center.

2. The washer of claim 1, wherein the first material and the second material are forged and fused together to form the washer.

3. The washer of claim 1, wherein the first material and the second material are separate parts that are integrated together to form the washer.

4. The washer of claim 1, the first material comprises: steel selected from carbon steel, spring steel, and stainless steel; a metal selected from copper, brass, aluminum, titanium, iron, bronze, and zinc; an alloy selected from silicon bronze, nickel alloys; polymers selected from thermoplastic and thermosetting polymers; and specialty materials selected from, fibers, ceramics, rubber, felt, leather, bimetals, and mica.

5. The washer of claim 1, wherein the first material is steel.

6. The washer of claim 1, the second material comprises steel selected from carbon steel, spring steel, and stainless steel; a metal selected from copper, brass, aluminum, titanium, iron, bronze, and zinc; an alloy selected from silicon bronze, nickel alloys; polymers selected from thermoplastic and thermosetting polymers; and specialty materials selected from, fibers, ceramics, rubber, felt, leather, bimetals, and mica.

7. The washer of claim 1, wherein the second material is copper.

8. The washer of claim 1, wherein the washer has a circular or a polygonal shape.

9. The washer of claim 8, wherein the washer has a hexagonal shape.

10. The washer of claim 1, wherein the surface of the washer is rough, wherein the rough surface is achieved by cutting lines or shapes on the surface of the second material.

11. A system comprising:
a nut;
a bolt with a bolt head connected to a threaded bolt screw;
a washer, wherein the washer comprises:
a first material and a second material;
wherein the first material surrounds the second material, wherein the first material is harder than the second material, and wherein the second material has a threaded hole in its center;
a substrate body, sandwiched between the washer and the nut; and
wherein the second material has a diameter greater than a diameter of the nut.

12. The washer of claim 11, wherein the first material and the second material are forged and fused together to form the washer.

13. The washer of claim 11, wherein the first material and the second material are separate parts that are integrated together to form the washer.

14. The washer of claim 11, wherein the first material is steel.

15. The washer of claim 11, wherein the second material is copper.

16. The washer of claim 11, wherein the washer has a circular or a polygonal shape.

17. The washer of claim 16, wherein the washer has a hexagonal shape.

18. The washer of claim 1, wherein the surface of the washer is rough, wherein the rough surface is achieved by cutting lines or shapes on the surface of the second material.

19. The system of claim 11, wherein the washer and the nut are locked on any position on the threaded bolt screw of the bolt using two or more washer-nut pairs.

20. A method comprising the steps of:
providing a washer, a nut, and a bolt with a bolt head connected to a threaded bolt screw having male and female threads, wherein the washer comprises:
a first material and a second material;
wherein the first material surrounds the second material, wherein the first material is harder than the second material, and wherein the second material has a threaded hole in its center having male and female threads, wherein the second material has a diameter greater than a diameter of the nut;
passing the threaded bolt screw through the threaded hole in the center of the washer;
passing the threaded bolt screw through a hole in a substrate;
fixing the nut onto the threaded bolt screw such that the substrate is sandwiched between the washer and the nut; and
a resulting pressure forcing the thread of the second material of the washer to inflate and squeeze into the mating thread of the threaded bolt screw to provide an anti-loosening effect.
